(19) United States
(12) Patent Application Publication
(10) Pub. No.: US 2017/0368495 A1
(43) Pub. Date: Dec. 28, 2017

(54) METHODS FOR CARBON DIOXIDE CAPTURE

(71) Applicants: Rachid Mabrouk, Munich (DE); Stevan Jovanovic, North Plainfield, NJ (US); Ramachandran Krishnamurthy, Piscataway, NJ (US)

(72) Inventors: Rachid Mabrouk, Munich (DE); Stevan Jovanovic, North Plainfield, NJ (US); Ramachandran Krishnamurthy, Piscataway, NJ (US)

(21) Appl. No.: 15/189,347

(22) Filed: Jun. 22, 2016

(51) Int. Cl. B01D 53/14

(52) U.S. Cl. CPC B01D 53/145; B01D 53/1493; B01D 53/1425; B01D 53/1475; B01D 2252/204

(57) ABSTRACT

A method for separating carbon dioxide from a flue gas stream wherein the flue gas stream is fed to an absorber column thereby producing a carbon dioxide depleted flue gas stream and wherein carbon dioxide absorbed from the carbon dioxide rich flue gas stream in the solvent is fed from the absorber column to a stripper column as a carbon dioxide rich solvent blend. The method is an improvement over prior carbon dioxide separation process by feeding the flue gas stream to a gas pre-treatment device prior to feeding into the absorber column preferably for decreasing the oxygen content in the flue gas and recycling a carbon dioxide product from the stripper column to the absorber column to increase the carbon dioxide content in the flue gas.

### BACKGROUND OF THE INVENTION

The present invention relates to a method for capture carbon dioxide from a gas stream, particularly a flue gas stream and particularly using absorption desorption technology.

In a typical solvent regeneration process, there is a cost factor in the thermal energy required to regenerate the solvent. There is also a cost associated with solvent degradation as the solvent will need to be replaced periodically. The more frequent this replacement is the more expensive the process is to operate.

The present invention will provide advantages with respect to these issues by using less energy to regenerate the solvent and extending the life time of the solvent. By achieving both these advantages, the present invention provides both economic and environmental advantages over previous carbon dioxide extraction processes.

The present invention further provides a higher thermal efficiency by allowing higher carbon dioxide content in the flue gas thereby allowing higher partial pressures of carbon dioxide and therefore fast carbon dioxide absorption kinetics. There will be less solvent emissions due to higher lean solvent inlet temperatures. By using a deoxygenation unit, the reduction in oxygen content in the gas allows for a longer life time of the solvent and increases the carbon dioxide content in the flue gas by burning any desulfurized hydrocarbons. The steam generated by the de-oxygenated reactor can be used either for solvent regeneration or integrated with the power steam cycle.

### SUMMARY OF THE INVENTION

The present invention provides for an efficient way to capture carbon dioxide from a flue gas stream. The process of the invention will improve upon problems that are frequently encountered in a solvent extraction process. The thermal energy that is required to regenerate the solvent in the absorber column is typically 7 to 10% less for separating the carbon dioxide from the flue gas using the process of the present invention. Further by removing oxygen from the flue gas stream with a deoxygenation unit prior to the flue gas stream entering the absorber column, the life of the solvent in the amine separation process is extended.

By allowing for higher carbon dioxide content in the flue gas, higher thermal efficiency can be achieved resulting in faster carbon dioxide absorption kinetics. Further there are less solvent emissions due to higher lean solvent inlet temperatures. The benefits of the deoxygenation unit in the gas separator will reduce the oxygen content in the flue gas and extend the life of the solvent and increase the carbon dioxide content in the flue gas stream by burning any desulfurized hydrocarbons source. Lastly, the steam that is generated in the deoxygenation reactor can be used either for solvent regeneration in the stripper column or integrated with the power steam cycle of the separation process.

In a first embodiment of the invention there is disclosed a method for separating carbon dioxide from a flue gas stream wherein the flue gas stream is fed to an absorber column thereby producing a carbon dioxide rich flue gas stream wherein carbon dioxide absorbed from the carbon dioxide rich flue gas stream is fed from the absorber column to a stripper column as a carbon dioxide rich solvent blend, the improvement comprising feeding the flue gas stream to a gas separator device prior to feed into the absorber column and recycling a fraction of carbon dioxide product from the stripper column to the absorber column.

In a second embodiment of the invention, there is disclosed a method for separating carbon dioxide from a flue gas stream comprising feeding the flue gas stream to a gas separator device; feeding the separated flue gas stream to an absorber column thereby forming a carbon dioxide rich solvent blend; absorbing carbon dioxide from the carbon dioxide rich flue gas stream thereby forming a carbon dioxide rich solvent blend and feeding the carbon dioxide rich solvent blend to a stripper column wherein carbon dioxide is separated and recovered, wherein the recovered carbon dioxide is recycled to the absorber column.

The gas separator device is typically an oxygen separation device. This oxygen separation device can preferably be a deoxygenation unit.

The flue gas stream is fed to a blower or compressor before being fed into the absorber column and preferably after receiving the flue gas stream that has been treated for oxygen removal.

The absorber column uses an amine-based solvent. Typically then, the carbon dioxide will absorb into the solvent material and separate out from the other components of the carbon dioxide rich flue gas stream forming the carbon dioxide rich solvent blend which is extracted from the bottom of the absorber column.

The operation temperature in the stripper is relatively higher than the absorber column B, 110° C. preferably 120° C. Low pressure steam is used to supply the heat required to release the absorbed CO₂ from the rich solvent.

### BRIEF DESCRIPTION OF THE DRAWINGS

FIG. 1 is a schematic of the absorption-desorption process for carbon dioxide separation according to the present invention.

FIG. 2 is a expanded schematic representation of the flue gas separation unit.

FIG. 3 is a graph illustrating the impact of carbon dioxide content of a gas stream on specific energy.

### DETAILED DESCRIPTION OF THE INVENTION

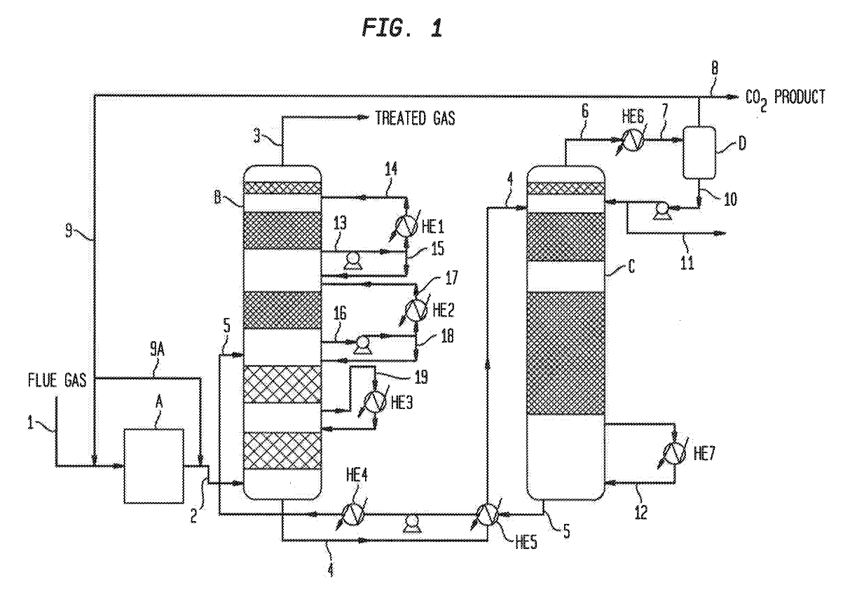

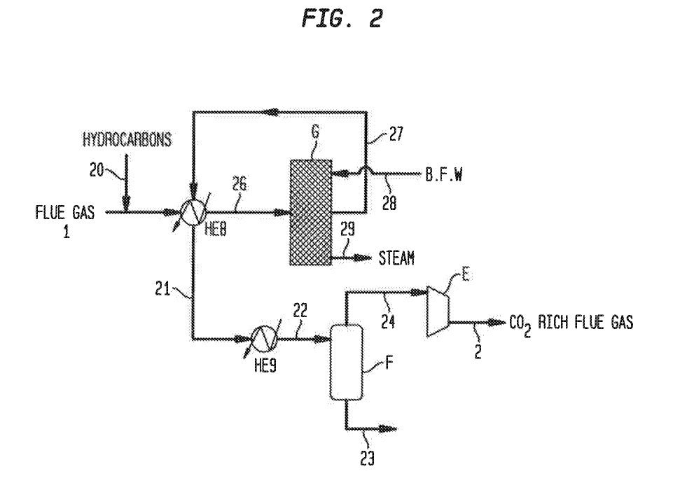

Turning to FIG. 1, flue gas is fed through line 1 to the feed gas separator A which is defined in greater detail in FIG. 2. The feed gas separator A operates to separate out a carbon dioxide rich flue gas from the flue gas received via line 1 and to assist in removing oxygen from the flue gas stream.

This carbon dioxide rich flue gas is fed through line 2 to absorber B. Typically the absorber column uses an amine-based solvent. The absorber column B utilizes external heat exchangers to assist in inter-stage cooling of the solvent stream as the temperature rises through the column.

The carbon dioxide rich flue gas stream 2 enters the absorption at the bottom of the column B. Carbon dioxide gas molecules are then absorbed in the solvent flowing downward, countercurrent to the flue gas flow. Structured packing material is placed in the column to enhance gas-liquid contact. The flue gas continues to flow upward and gets depleted of carbon dioxide due to its absorption in the solvent. The recirculating solvent stream gets richer in carbon dioxide as it flows downward in the absorber.

The absorber column consists of two (shown in FIG. 1) or more sections in the bottom for solvent circulation. The recirculating solvent enters at the top of this section. Above this section are one or more wash sections (two are shown in FIG. 1) whose purpose is to collect any entrained solvent from the absorption section.

The carbon dioxide rich solvent stream intermediate between the two absorption sections passes through line 19 where it is cooled in the heat exchanger HE3 before being returned to the absorber column B above the bottom section. This inter-cooling increases the solvent absorption capacity.

In the wash sections above the absorption sections, water or other fluid is circulated and any entrained solvent is absorbed in the wash fluid. In FIG. 1, two wash sections are shown. In the lower wash section, the water containing some of the solvent is collected at the bottom, flows through pump 16 and cooled in heat exchanger HE2 and then recirculated around this section through pipe 17. A portion of the wash fluid can be diverted to the absorption section below through line 18. Similarly, the wash fluid from the upper wash section is collected and circulated through pump 13 and cooled in heat exchanger HE1 and back through line 14. A portion of the circulating wash fluid is diverted through pipe 15 to the wash section below.

Thus, the treated flue gas stream mainly nitrogen (90 to 98 vol %), oxygen (approximately 1 to 8%) and CO₂ that is not absorbed (typically <1 vol %) can then be emitted from the top of absorber column B through line 3 to the atmosphere. This treated gas stream is saturated with water. The top of the column may contain a metal mesh demister pad to further prevent any free water or solvent from carrying over with the treated gas.

The carbon dioxide that is separated from the carbon dioxide rich flue gas into the recirculating solvent stream is transferred from the bottom of absorber column B through line 4. This stream passes through heat exchanger HE5 where it will be raised in temperature and is fed into the stripper column C.

The carbon dioxide released from the CO₂ rich solvent in the stripper column C will exit through line 6 and pass through heat exchanger HE6 and fed through line 7 into knock out drum D to separate CO₂ gas stream from water and any solvent carry over. The final carbon dioxide product will exit the unit operation through line 8 and be either captured as carbon dioxide product for use in specific industrial operations. A fraction might be recycled, to increase carbon dioxide content in the raw flue gas, or returned through line 9 to line 1 where it will be fed into the feed gas pre-treatment unit A to be fed into absorber column B. Alternately, the recycle CO₂ stream can also be added to line 2 through line 9A prior to entering the absorber column B with flue gas. The liquid phase stream from the flash unit operation D can be returned to the stripper column C through line 10 or be fed through line 10 to line 11 as a purge where it will be discharged to the atmosphere in an environmentally proper manner.

During operation of the stripper column C, the recirculating solvent stream which is now lean in carbon dioxide can be withdrawn through the bottom section as stream 12 and fed through steam heated heat exchanger HE7 before it is returned back to the stripper column C as a vaporized gas stream. The carbon dioxide depleted solvent (lean solvent) is discharged from the stripper column C through line 5 and pass through heat exchanger HE5 and heat exchanger HE4 where they will be warmed up before being fed into absorber column B for separation.

FIG. 2 is an expanded representation of the feed gas separator A from FIG. 1. The same flue gas stream is fed through line as in FIG. 1 into a feed effluent heat exchanger HE8 where it is heated up. Hydrocarbons from an external source are fed through line 20 into the flue gas feed line 1 to act as a fuel in the deoxygenation unit G. This is an important aspect of the invention as less oxygen being fed into the absorber column will significantly reduce the degradation of the solvent as caused by the oxygen.

The heated flue gas stream is fed through line 26 to a water cooled deoxygenation unit G which receives boiler feed water through line 28 and will emit steam through line 29. This deoxygenation unit G will raise the temperature of the flue gas as it passes through to line 27. The hot flue gas stream will pass through a feed effluent heat exchanger HE8 where it will be cooled and enter line 21 where it will be fed into heat exchanger HE9 where the flue gas stream will be further reduced in temperature to dew point.

This flue gas stream will then be fed through line 22 into a gas-liquid separator unit F where the gas phase is separated from the Liquid phase. The flue gas stream is separated in the unit F with the carbon dioxide rich flue gas stream exiting the top of the flash unit F through line 24 and being fed into a compressor E where its pressure will be increased prior to being fed through line 2 to the absorber column B as described in FIG. 1. The water condensates will exit the flash unit F through line 23 where it is discharged to the atmosphere in an environmentally proper manner.

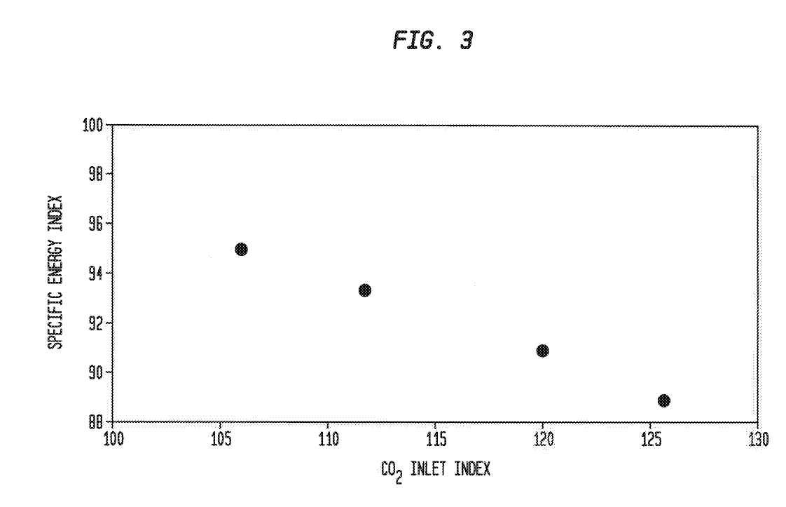

As shown in FIG. 3, the amount of carbon dioxide content of a flue gas stream is measured on the X axis versus the specific energy index measured on the Y axis. The process of the present invention will provide for higher thermal efficiency by allowing higher carbon dioxide content in the flue gas which in turn allows higher partial pressure of carbon dioxide and therefore faster carbon dioxide absorption kinetics resulting in a smaller height requirement for the absorber column.

Therefore the overall performance of the system for removing carbon dioxide from a flue gas stream is improved. The advantages namely are the recycle of a carbon dioxide product stream to the absorption column; removal of oxygen from the flue gas stream prior to entering the absorption column; relocation of a flue gas blower to before the absorption column thereby operating the absorber column at a positive pressure and a higher lean solvent inlet temperature of 50 to 60° C. rather than 40° C. or lower.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A method for separating carbon dioxide from a flue gas stream wherein the flue gas stream is fed to an absorber column thereby producing a carbon dioxide rich solvent stream and a carbon dioxide depleted treated gas stream wherein the carbon dioxide rich solvent stream is fed from the bottom of the absorber column to a stripper column as a carbon dioxide rich solvent wherein the carbon dioxide is separated as a gaseous product by application of thermal energy, the improvement comprising feeding the flue gas stream to a gas pre-treatment device prior to feeding into the absorber column and recycling a fraction of carbon dioxide product from the stripper column to the absorber column.

2. The method as claimed in claim 1 wherein the gas pre-treatment device is a deoxygenation unit.

3. The method as claimed in claim 2 wherein the oxygen separation device is a deoxygenation unit.

4. The method as claimed in claim 1 wherein the flue gas stream is fed to a blower or compressor for increasing the flue gas stream pressure before being fed to the absorber column.

5. The method as claimed in claim 1 wherein the absorber column uses an amine-based solvent.

6. The method as claimed in claim 1 wherein the carbon dioxide rich solvent blend from the absorber column is raised in temperature to boiling point before being fed to the stripper column.

7. The method as claimed in claim 1 wherein the recycled carbon dioxide from the stripper column is fed to the gas pre-treatment device before entering the absorber column.

8. A method for separating carbon dioxide from a flue gas stream comprising feeding the flue gas stream to a gas pre-treatment device; feeding the oxygen depleted flue gas stream to an absorber column; absorbing carbon dioxide in a recirculating solvent from the carbon dioxide rich flue gas stream thereby forming a carbon dioxide rich solvent blend and feeding the carbon dioxide rich solvent blend to a stripper column wherein carbon dioxide is separated by applying thermal energy and recovered, wherein the recovered carbon dioxide is partially recycled to the absorber column.

9. The method as claimed in claim 8 wherein the gas pre-treatment device is an oxygen consuming device.

10. The method as claimed in claim 9 wherein the oxygen consuming device is a deoxygenation unit.

11. The method as claimed in claim 8 wherein the flue gas stream is fed to a blower or compressor for increasing the flue gas stream pressure before being fed to the absorber column.

12. The method as claimed in claim 8 wherein the absorber column uses an amine-based solvent.

13. The method as claimed in claim 8 wherein steam is added to the stripper column thereby providing the thermal energy to release carbon dioxide present in the carbon dioxide rich solvent blend.

14. The method as claimed in claim 8 wherein the carbon dioxide rich solvent blend from the absorber column is raised in temperature to boiling point before being fed to the stripper column.

15. The method as claimed in claim 8 wherein the recycled carbon dioxide from the stripper column is fed to the gas pre-treatment device before entering the absorber column.
